(19) United States
(12) Patent Application Publication
(10) Pub. No.: US 2014/0009598 A1
(43) Pub. Date: Jan. 9, 2014

(54) Pipeline Inspection Piglets

(71) Applicants: Thomas O'Donnell, New York, NY (US); Theodore James Mallinson, Houston, TX (US); Yakup Genc, Dayton, NJ (US); Anton Schick, Velden (DE)

(72) Inventors: Thomas O'Donnell, New York, NY (US); Theodore James Mallinson, Houston, TX (US); Yakup Genc, Dayton, NJ (US); Anton Schick, Velden (DE)

(73) Assignee: Siemens Corporation, Iselin, NJ (US)

(21) Appl. No.: 13/417,685

(22) Filed: Mar. 12, 2012

(51) Int. Cl. F16L 55/26

(52) U.S. Cl. CPC F16L 55/26
USPC 348/84

(57) ABSTRACT

For pipeline inspection, a small, untethered capsule (a “piglet”) images from within a pipeline. The capsule is small enough that rotation about any of three orthogonal axes while within the pipeline is possible. Movement both along the pipeline and perpendicular to the longitudinal axis is possible. To assure images of the pipeline without viewing gaps, the field of view for imaging surrounds the capsule without a gap. Given the possible rotation and translation, the captured images may be motion compensated to provide oriented images of a length of the pipeline.

### BACKGROUND

The present invention relates to pipeline inspection.

Pipelines may be damaged or deteriorate over time. Pipeline inconsistencies may include lack of roundness, material deposition, presence of scale, loss of thickness, and other phenomena. Inconsistencies may indicate corrosion or plug forming events. Left unaddressed, catastrophic loss of containment and/or reduction in productivity may result.

The interior of the pipeline may be inspected to find inconsistencies. An inspection pig sized to about the inner diameter of the pipeline is inserted into the pipeline. However, deploying an inspection pig may incur substantial overhead, such as costs due to the temporary shutdown of output during the inspection procedure.

Some pipeline may not normally be inspected by pigging. For example, pigging in injection lines, unlooped production lines, trunk lines, and lines with short radius bends (e.g. jumpers and infield flow lines) may cause significant hardship. However, failure to inspect may result in failure to remediate problems.

### BRIEF SUMMARY

By way of introduction, the preferred embodiments described below include methods, systems, pigs, and computer readable media for pipeline inspection. A small, untethered capsule images from within a pipeline. The capsule is small enough that rotation about any of three orthogonal axes while within the pipeline is possible. Movement both along the pipeline and perpendicular to the longitudinal axis is possible. To assure images of the pipeline without viewing gaps, the field of view for imaging surrounds the capsule without a gap. Given the possible rotation and translation, the captured images may be motion compensated to provide oriented images of a length of the pipeline.

In a first aspect, a system is provided for pipeline inspection. A pipeline has an inner diameter. A pig has a maximum dimension less than half of the inner diameter. The pig is free of a tether such that the pig with the maximum length is operable to rotate along any of three orthogonal axes within the pipeline. A sensor connects with the pig. The sensor is operable to scan an interior of the pipeline as the pig progresses along the pipeline within the pipeline.

In a second aspect, a pipeline inspection pig includes a housing. A plurality of cameras connects with the housing. The plurality of cameras has a combined field of view which encompasses all directions. A memory is within the housing and connects with the cameras. The memory is operable to store images from the cameras. A power source within the housing connects with the cameras.

In a third aspect, a method is provided for inspecting a pipeline. A capsule is placed into a pipeline. Images of the pipeline are recorded as the pig moves along a length of the pipeline and moves along an axis perpendicular to the length of the pipeline. Motion compensation is applied to the images.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 shows one embodiment of a system for pipeline inspection;

FIG. 2 illustrates one embodiment of a pig for pipeline inspection;

FIG. 3 illustrates positioning of a camera in a recess, according to one embodiment;

FIG. 4 illustrates another embodiment of a pig for pipeline inspection; and

FIG. 5 is a flow chart diagram of one embodiment of a method for pipeline inspection.

### DETAILED DESCRIPTION OF THE DRAWINGS AND PRESENTLY PREFERRED EMBODIMENTS

Pipeline inspection is modeled after capsule endoscopy. A pig is small (a “piglet”) relative to the inner diameter of the pipeline. Rather than diameter matching to limit motion perpendicular to the flow, the small pig travels independently (e.g., without tether) along the pipeline with freedom to move in various directions, not just longitudinally. The pig may be small enough to be introduced into the system via a chemical injection line, such as a methanol line.

As the small pig travels, information along the path of travel is locally recorded. Collected video is used to determine the locations of interior defects by detecting and counting flanges and other landmarks.

The piglet may provide for convenient inspection of the interior of a pipeline in a minimally invasive manner. Through the piglet system, operational disruption may be kept to a minimum. Frequent inspection may be facilitated so that problems which might lead to disaster may be caught early. Reduced disruption may encourage or enable the operator to retrieve data on a more frequent basis, even for lines not normally pigged or where pigging with a larger pig may cause significant hardship. Injection lines, unlooped production lines, trunk lines, and lines with short radius bends (e.g. jumpers and infield flow lines) may be inspected. Through management of the inspection, onset of appreciable degradation may be predicted, and the appropriate action taken prior to asset failure.

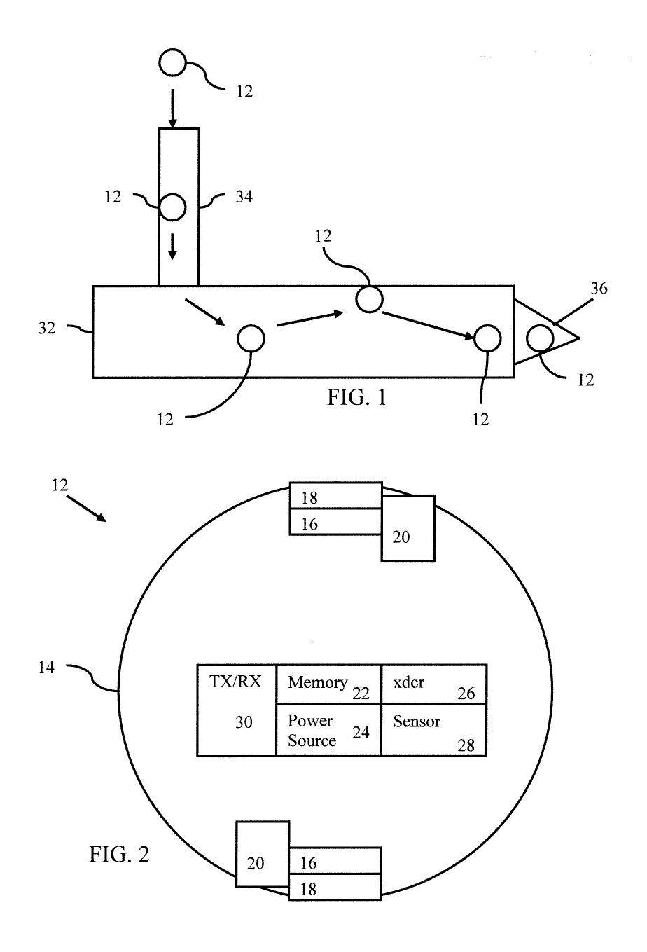

FIG. 1 shows a system 10 for pipeline inspection. The system 10 includes a pig 12, a pipeline 32, a feeder line 34, and a sieve 36. Additional, different, or fewer components may be used. For example, the feeder line 34 and/or the sieve 36 are not provided. As another example, jumpers, bends, valves, branches, or other pipeline structures are provided.

The pig 12 is shown in various locations relative to the feeder line 34 and the pipeline 32. This represents only one pig 12 being used. The pig 12 progressing along the pipeline 32 is represented. In other embodiments, multiple pigs 12 may be used at a same time for the same section or different sections of the pipeline 32.

The pipeline 32 is a metal (e.g., steel or ductile iron), concrete, plastic, or other material. Oil, gas, liquid, or other fluids are transported by flow through the pipeline 32. The exterior of the pipeline 32 may be coated in insulation material. Any size pipeline 32 may be used, such as eight inch to three foot inner or outer diameters. Pipelines are used on land, underwater (e.g., subsea), in cold climates, in hot climates, and in temperate climates. For example, the pipeline 32 is deployed in a high pressure, deep sea environment. The pipeline 32 may include joints, turns or bends, valves, or other structures.

FIG. 1 is not to scale as the pipeline 32 may have a much greater length between the feeder line 34 and the sieve 36. The pig 12 is for inspecting any length of pipe. For example, 10-600 feet of pipeline 32 may be inspected. As another example, miles of pipeline 32 may be inspected with the same pig 12. The entry and exit points for the pig 12 may be other than the feeder line 34 and/or the sieve 36.

The feeder line 34 is a chemical injection line. Other feeder lines 34 may be used. The feeder line 34 has a smaller inner and/or outer diameter than the pipeline 32. The feeder line 34 connects to the pipeline 32 at any angle for injecting fluids or other materials into the pipeline 32. The feeder line 34 may be a branch line.

In alternative embodiments, the feeder line 34 is not provided and/or not used. The pipeline 32 may include a sty or pig station for inserting a standard pig, such as a pig sized to the inner diameter of the pipeline 32. Alternatively, the pipeline 32 may include a piglet station for injecting small sized pigs in a portal of the pipeline 32.

FIGS. 2-4 show example embodiments of the pig 12. The pig 12 is a pipeline inspection pig. Referring to FIG. 2, the pig 12 includes a housing 14, one or more sensors 16, respective lenses 18, light sources 20, memory 22, power source 24, transducer 26, additional sensor 28, and transceiver 30. Additional, different, or fewer components may be used. For example, the transducer 26 and/or additional sensors 28 are not provided. As another example, separate memories 22 are provided for respective sensors 16. In yet another example, a transmitter is used instead of a transceiver 30.

The housing 14 is plastic. Other materials may be used, such as metal. The housing 14 is formed from one type of material or may include different types of material.

The housing 14 is of any shape. In one embodiment, the housing 14 is a sphere, such as shown in FIG. 2. In other embodiments, the housing 14 has a bullet shape, such as shown in FIG. 4. Oblong, cuboid, or other shapes may be used.

The housing 14 is generally smooth and flat. The housing 14 may be textured. In other embodiments, the housing 14 includes one or more extensions, such as fins, rudders, propellers, or other devices for passively or actively steering and/or moving the pig 12.

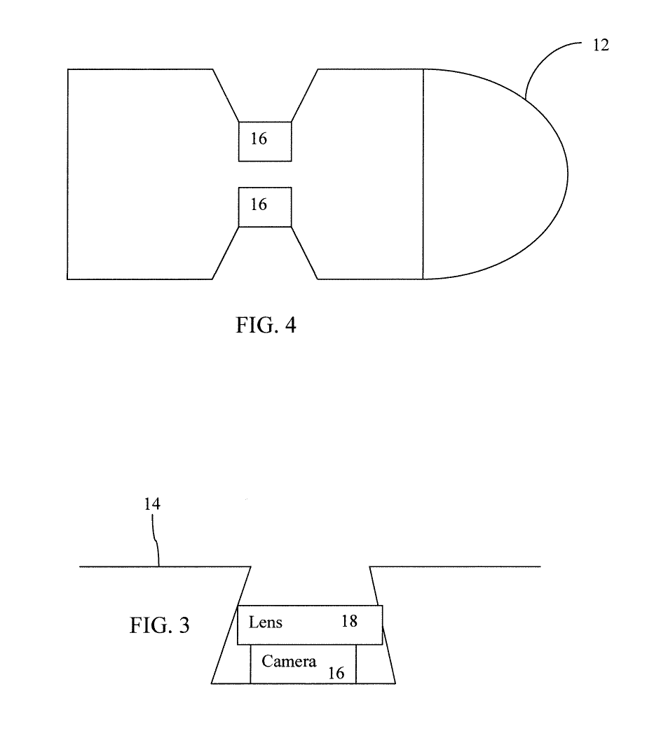

The housing 14 may include one or more recesses. The recess is a hole, indentation, or other variation from smooth or flat. FIGS. 3 and 4 show example recesses. FIG. 3 shows the recess as a hole or indentation that is narrower by an outer surface and wider spaced away from the outer surface of the housing 14. FIG. 4 shows the recess as narrower away from the outer surface. The recess may have other shapes in cross section, such as the same width regardless of depth or an hour glass shape.

The recess may allow access. For example, the recess is a port for electrical and/or physical connection to the pig 12. In the example shown in FIGS. 3 and 4, the recess is for the sensor 16 and/or the lens 18. The recess may protect the lens 18 and/or sensor 16. For example, the lens 18 and/or sensor 16 may avoid contact with the interior of the pipeline 32. Avoiding contact may limit scratches or other harm that effects measurements. The recess is of any depth, such as millimeters or centimeters.

The housing 14 has a maximum length. For the spherical shape, the diameter is the maximum length. For the bullet shape, the maximum length is from the tip of the front (right side in FIG. 4) to the back. Regardless of shape of the pig 12, the maximum length allows the pig 12 to fit within the pipeline 32 and/or within the feeder line 34.

The maximum dimension (i.e., length) of the pig 12 is five inches or less. For example, the maximum dimension is three inches or less. Larger or smaller lengths may be used.

Given the small size relative to the inner diameter, the pig 12 may move longitudinally in the pipeline 32 or along other directions. The pig 12 may move more than the maximum dimension in a direction perpendicular to the longitudinal axis of the pipeline 32. Two, three, six, ten or more inches in clearance may be provided all around with the pig 12 while at the center of the pipeline 32.

The maximum dimension is less than half of the inner diameter of the pipeline 32. Where the pipeline 32 includes narrower and wider portions, the pig 12 has a maximum dimension less than half of the inner diameter of the narrower, wider, or narrower and wider portions. By having a maximum dimension less than half the inner diameter, the pig 12 may rotate along any of three orthogonal axes within the pipeline 32. The size of the pig 12 does not prevent the pig 12 from rotating about an axis perpendicular to the direction of flow (e.g., does not prevent the pig 12 from rotating end over end). While the pig 12 may be prevented from rotating due to bumping into the pipeline 32, the size of the pig 12 is such that it is possible to rotate fully (e.g.,) 360° around any axis. In alternative embodiments, the maximum dimension of the pig 12 is greater than half of the inner diameter.

The pig 12 may be sized the same regardless of the size of the pipeline 32. A one size fits all, most, many, or multiple pipeline sizes may be used. To limit stocking or inventory management problems, the same pig 12 or same size pig 12 may be used in different sized pipelines 32. For example, a pig 12 with a three inch or less longest dimension may be used in 8 inch, 12 inch, 18 inch, 24 inch, 32 inch and other sized pipelines 32.

The size of the pig 12 and corresponding housing 14 may be based on the inner diameter of the feeder line 34. By having the pig 12 be small enough to fit into the feeder line 34, the feeder line 34 may be used to insert the pig 12 into the pipeline 32. The pig 12 may have a maximum dimension greater than the inner diameter of the feeder line 34, but still be sized to fit within the feeder line 34. Access to a port or opening for inserting into a feeder line 34 may be more convenient or less disruptive to production. For example, the pig 12 is sized to fit in a chemical injection line.

The housing 14 has any thickness. The housing 14 may include one or more chambers. In one embodiment, the housing 14 is formed as a Dewar vessel. The sensors 16 may have deteriorated performance at higher or lower temperatures. For example, CCD cameras have poor signal-to-noise ratio at higher temperatures. The housing 14 may house the temperature sensitive interior components in a Dewar vessel. The Dewar vessel may keep the components sufficiently cool or warm for a given range along the pipeline 32, such as for a mile.

In an additional or alternative embodiment, chemical containers, valves, pump, reaction chamber, and/or conduits are provided in the housing 14 for an endothermic reaction. By causing the endothermic reaction, the pig 12 may be cooled. Where the length of the journey of the pig 12 along the pipeline 32 is long enough that the insulating properties of the Dewar vessel are ineffective, the endothermic region may maintain the temperature of the pig 12 at a desired level.

The housing 14, and thus the pig 12, are free of a tether. A mechanical, electrical, or communications tether is not provided while the pig 12 is in use within the pipeline 32. The pig 12 is free of a tether for operation (e.g., inspection) in the pipeline. A connector or plug may be provided for connecting the pig 12 to a computer, power source (e.g., charger) or other device when outside the pipeline 32. In alternative embodiments, the pig 12 and housing 14 are tethered during inspection.

The housing 14 may be layered. For example, a protective housing may surround the housing 14 of the pig 12. The protective housing helps insulate the pig 12 and prevents damage to the lenses 18. Once the pig 12 reaches a desired location or after a predetermined amount of time, the protective housing retracts or is discarded. For example, a motor releases latches, causing the protective housing to fall away. The pig 12 may then begin measuring the pipeline 32.

Referring to FIG. 2, the lens 18 is glass, plastic, polymer, or other material. In one embodiment, the lens 18 is a synthetic sapphire lens or other scratch resistant material that passes the energy used for sensing by the sensor 16. The synthetic sapphire lens may be used for optical imaging. In one embodiment, a sapphire window is provided where the window also functions as a lens or where a separate lens (e.g. plastic or glass) is provided. A window may be provided without a lens.

The lens 18 may shape the energy used for sensing. The lens 18 may provide focus, such as narrowing, fanning, or expanding out the field of view. In other embodiments, the lens 18 does not focus.

One or more lenses 18 are provided for each sensor 16. The lenses 18 may direct or merely pass energy for sensing. Similarly, mirrors or reflectors may be provided. The lenses 18 are positioned adjacent to the sensors 16, such as in direct physical contact. The lenses 18 may be spaced from the sensors 16.

The lens 18 may be coated with an oleophobic topcoat. The top coat may be chemically neutral to materials likely to be found in the pipeline 32. An oleophobic topcoat may repel and/or may prevent deposit or build up of oils and paraffins. Other topcoats may be used. The topcoat or coating of the lens 18 may limit mineral or other deposits on the lens 18.

The recessed sensors 16 may also limit build-up of debris. In an additional or alternative approach, the lens 18 is covered with layers of clear plastic film. Using layers may allow one or more layers to be removed or “shed.” Using an electrical or mechanical device, a layer may be removed during operation in the pipeline 32. The removal occurs periodically or upon detection of a sticky hydrocarbon deposit by the sensor 16.

FIGS. 2 and 4 show two lenses 18, one for each sensor 16. More lenses 18 may be provided for more sensors 16. The lenses 18 are formed as part of or integrated with the housing 14. In FIG. 2, the lenses 18 are flush with the outer surface. The lenses 18 may be separate inserts.

The sensors 16 are any device for measuring the pipeline 32. For example, the sensors 16 are ultrasound arrays for scanning the pipeline 32. In another example, the sensors 16 are cameras. The cameras may take snapshots or video. In one embodiment, charge-coupled devices (CCD) are used as cameras. Any size or resolution, such as 8 megapixels, may be used.

The sensors 16 are adjacent to the respective lenses 18. The lenses 18 may be deposited on, placed in contact with, or spaced apart by gas, fluid, gel, or solid from the sensors 16. The sensors 16 are positioned relative to the lenses 18 to make measurement through the lenses 18.

The sensors 16 connect with the housing 14. The connection may be indirect. The sensor 16 connects with the housing 14 by being connected with the lens 18. Alternatively or additionally, the sensor 16 is held in place by a bracket or mounting within the housing 14. The connection may be direct. For example, the lens 18 is formed as part of or integrated with the housing 14. The sensor 16 connects with the lens 18 or is held against the lens 18. As shown in FIG. 4, the sensor 16 may be placed in an aperture within the recess of the housing 14. The sensor 16 may be outside of the housing 14, such as positioned within the recess as shown in FIG. 3. The sensor may be within the housing 14, such as shown in FIG. 2. Where the housing 14 includes or is a Dewar vessel, the sensor 16 may be positioned in or outside of the Dewar vessel. For temperature sensitive sensors 16, positioning inside the Dewar vessel may help maintain a temperature or limit the speed of change of temperature. The lens 18 may form part of the Dewar vessel for imaging with the sensor 16 from inside the Dewar vessel.

Any number of sensors 16 may be provided. Where the pig 12 may be steered, one, two, three, four or other numbers of sensors 16 may be used. For example, a single sensor 16 positioned in the front of a bullet-shaped pig 12 images at a wide angle in-front of the pig 12. As another example, two, three or more sensors 16 are spaced around the circumference of the pig 12 directed at the walls of the pipeline 32, such as shown in FIG. 4. In yet another example, six or more sensors 16 are used to image in all directions, such as six or more sensors 16 equally spaced around a sphere.

The sensors 16 are positioned to scan the interior of the pipeline 32 as the pig 12 progresses along the pipeline 32. With the pig 12 within the pipeline 32, the pipeline 32 may be imaged from within the pipeline 32. Any field of view for a given sensor 16 may be used, such as viewing in a 90° cone. Narrow or wide fields of view may be used.

Where the pig 12 may rotate, providing fields of view from various sensors 16 may allow continuous inspection of all parts of the interior of the pipeline 32 as the pig 12 passes. The fields of view for two or more sensors 16 may cover all regions around the pig 12. For example, images in all directions may be captured. The fields of view overlap, at least within inches of the pig 12. Regardless of the rotation of the pig 12 while moving, all points in a conceptual ring of the inner diameter of the pipeline 32 may be visible at any given time. Where the pig 12 is very close, such as within an inch or two, to the wall, a gap in the field of view may result.

The light source 20 is an LED or projector. A laser or other light source may be used. The light source 20 may include a lens 18 or not. The light source 20 illuminates all of or within the field of view of the sensor 16. A separate light source 20 is provided for each sensor 16. Fewer or more light sources 20 may be used than sensors 16. In alternative embodiments, the light source 20 is not provided, such as for ultrasound based sensing.

For camera or optical sensing, the light source 20 may be structured or unstructured. Structured light generates a pattern, such as a grid of illumination. The structured light may assist in detecting inconsistencies in the pipeline 32. The inconsistencies may distort the pattern, making detection easier or more consistent. The same or different pattern may be provided for different light sources 20 and corresponding sensors 16. Using a different pattern may allow distinguishing the overlap or field of view of one sensor 16 from another. Differences in type, color, spacing, shape, or frequency may be used.

The memory 22 is within the housing 14, such as within a Dewar vessel of the housing 14. The memory 22 electrically connects to the sensors 16 or detection circuitry of the sensors 16. The electrical connection allows storage of measurements from the sensors 16. For example, the memory 22 stores images or video captured by cameras.

The size of the memory 22 is sufficient to store measurements at the desired resolution over the desired time. For example, the memory 22 is sufficient to capture low resolution (e.g., 800×600) images from all of the sensors 16 for enough time that the pig 12 may progress along about a mile of pipeline (e.g., at 10 m/s). More or less memory may be provided. More than one memory 22 may be used, such as providing a separate memory 22 for each sensor 16.

The pig 12 may include a processor for controlling the electronics. In one embodiment, the memory 22 stores instructions for programming the processor for pipeline inspection. The instructions for implementing the processes, methods and/or techniques discussed above are provided on non-transitory computer-readable storage media or memories, such as a cache, buffer. RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

The power source 24 is within the housing 14, such as within the Dewar vessel. The power source 24 connects with the sensors 16 and/or other electronics (e.g., transceiver 30 and the memory 22) of the pig 12.

The power source 24 is a battery. Any now known or later developed power source may be used. In alternative embodiments, the power source 24 is a generator. The motion of the pig 12 caused by flow in the pipeline 32 may be used to generate power, such as causing a weight on an arm to rotate and generating current from the rotation.

The transducer 26 converts electrical energy into vibration. In one embodiment, the transducer 26 is a piezoelectric block. In other embodiments, the transducer 26 is a mechanical arm and weight caused to vibrate. The transducer 26 is positioned against the housing 14 or generally within the pig 12. The transducer 26 may be activated to shake the pig 12. The shaking may cause any built up materials to be removed from the pig 12. For example, the shaking may cause materials in the recess blocking the sensor 16 to leave the recess. The shaking may cause material on the lens 18 to fall away.

The additional sensor 28 may be an inertial sensor. Rather than sensing the interior of the pipeline 32, the additional sensor 28 is used to motion compensate or sense motion of the pig 12. For example, a gyroscope or accelerometer may be used to determine relative motion over time for assembling the captured images into a consistent view of the pipeline 32. The additional sensor 28 aids in the recovery of motion and/or post processing of the recovered video or images. The relative motion may alternatively or additionally indicate position along the pipeline, such as the capsule detecting bends resulting in change of direction.

The additional sensor 28 may be an acoustic sensor. For example, a microphone or acoustic transducer is included within the housing 14. The acoustic sensor records vibrations or other noise. A pattern of noise over time may be used to indicate the position of the pig 12 along the length of the pipeline 32. A particular vibration (e.g., amplitude, frequency, bandwidth or other characteristic) may indicate a given position along the length. Both acoustic and inertial sensors may be used. In alternative embodiments, the addition sensor 28 is not provided.

The transceiver 30 is a radio or other electrical communications device. Bluetooth, Wi-Fi, or other communications formats may be used to communicate control information and/or recorded sensor data.

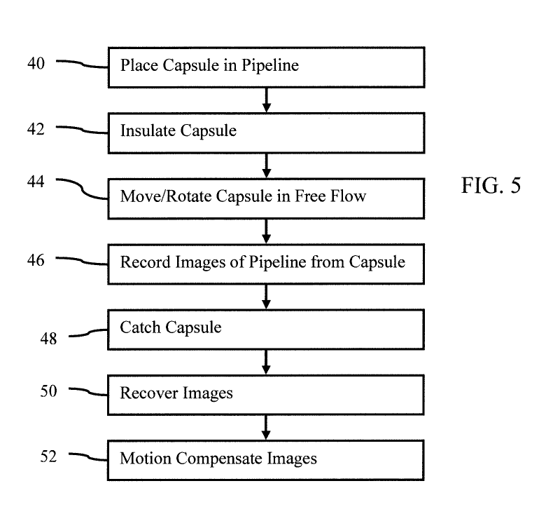

FIG. 5 shows a method for inspecting a pipeline. The method uses the system of FIG. 1, the pig of FIG. 2, the pig of FIG. 4, different pigs, and/or different systems. The acts are performed in the order shown or a different order. For example, act 42 occurs prior to act 40, but the effect of the insulation is noted for after placement in the pipeline. Acts 44 and 46 may occur simultaneously. Act 50 may occur after catching the capsule or while the capsule is moving in the pipeline in act 44 (e.g., before or without catching). In another example, act 52 is performed during movement in act 44 and recording of images in act 46.

Additional, different, or fewer acts may be used. For example, act 42 is not provided other than any insulation provided by the housing without a Dewar vessel. As another example, act 48 may be not performed, such as where the capsule is interrogated and images downloaded as the capsule passes by a station. In yet another example, act 52 is not performed.

In act 40, the capsule is placed into a pipeline. The placement may be manual. A user opens a plate or valve in the pipeline and releases one or more capsules into the pipeline. Alternatively, an automated placement is provided, such as a machine dispatching a capsule from a collection housed in a sty.

In one embodiment, the capsule is placed directly into the pipeline to be inspected. In other embodiments, the capsule is inserted into a feeder line, such as a chemical feeder line. The pressure or flow in the feeder line moves the capsule to the pipeline to be inspected.

Given the size and/or insertion technique, shutting down the pipeline for insertion may be avoided. A backflow preventer on the feeder line or the sty in the pipeline prevents pressure release. Using a pressure chamber or other transfer, the capsule is added to the pipeline while the flow of oil, gas, or other fluid continues in the pipeline. Shutting down of production for inspection may be avoided.

In act 42, the capsule is insulated. In particular, temperature sensitive electronics or other components are insulated. A Dewar vessel may be used. The insulation is by vacuum or active process in addition to any material related insulation. By sealing a vacuum chamber around the electronics, more optimal functioning may be maintained for a longer period of time. Other insulation, such as using plastic as the housing or other less thermally conductive materials than metal, may be used.

Active cooling or heating may be provided. For example, a heating element may be provided within the capsule. As another example, an endothermic reaction is created within the capsule for cooling.

In act 44, the capsule moves and/or rotates within the pipeline. The fluid flow of liquid or gas in the pipeline causes the capsule to move. For example, the capsule moves with oil at about 10 m/s. Other rates may be provided.

Since the capsule is smaller than the inner diameter, the capsule may move both along the longitudinal axis of the pipeline and also in other directions. FIG. 1 shows the capsule moving longitudinally, but also in a direction orthogonal to the longitudinal axis. Any range of movement may be provided, such as moving to and away from the walls over a range of at least one half the inner diameter of the pipeline. The capsule may or may not bump into, bounce off of, or contact the walls of the pipeline. The capsule free flows with the fluid in the pipeline. The fluid exerts pressure on the capsule to move the capsule.

Since the capsule is not tethered, the capsule may rotate. The rotation by be about any axis. Defining three orthogonal axes relative to the capsule and/or the pipeline, the capsule may rotate about any or all of the three orthogonal axes. The rotation along a given axis may be limited by fins or other steering. The size of the capsule otherwise allows for complete rotation within the pipeline. When the capsule is adjacent to a wall, a reverse rotation due to collusion may occur. The capsule, in a sense, tumbles through the pipeline.

In act 46, images are recorded. As the capsule moves along the length of the pipeline, images are captured and stored. The images may be optical (e.g., captured with a camera) or at other wavelengths (e.g., acoustic, ultrasound, infrared, ultraviolet, or x-ray).

The images are recorded for a set time. For example, the capsule is programmed to begin capturing images after a period of time, allowing the capsule time to enter the pipeline and/or flow to a region for inspection. In other embodiments, the imaging begins prior to or upon insertion into the pipeline or feeder pipeline (e.g., the user turns on the image capture prior to inserting the capsule). The images may be recorded until memory runs out, a period expires, the capsule is captured, or. other trigger. The time for recording may be preprogrammed or not.

The capsule may retain or discard images and their related information based on some predetermined criteria. For example, processing is performed within the capsule so that record “bad” sections and not other sections of the pipe are recorded. In other embodiments, different criteria are used or all images are recorded, such as to establish a baseline for corrosion monitoring. In addition to image data, temperature, velocity, and/or pressure may be recorded at the same or different frequency or basis as image data.

The images are recorded from all of the cameras. The cameras may operate simultaneously or in a sequential or interleaved fashion. In one embodiment, the cameras operate regardless of an orientation of the capsule. In other embodiments, the orientation of the capsule may be used. For example, the forward most facing camera is used. As the capsule rotates, the camera to capture images may or may not change. Similarly, the cameras closest to the walls of the pipeline may be used while others are not. Similarly, the light sources may be activated only when the associated camera is to be operated or are left on regardless of camera operation.

The fields of view provide for a full 360° range covered by the cameras. As the capsule moves along the pipeline, every inch, foot, yard, or spacing at the desired resolution is captured. The fields of view may similarly extend in all directions, such as 360° range about all axes. This full field of view in three-dimensions is provided at least at a range from the capsule, such as within a centimeter, inch, or few inches of the capsule. Images of the pipeline from all directions from the capsule may be captured.

The images are captured periodically. The camera may not be active at all times. Any capture repetition frequency may be used. In other embodiments, the images are captured as part of a video. In the video, a sequence of images is captured at a rate on the magnitude of the rate used to record or generate the images (e.g., CCD operation rate).

In act 48, the capsule is captured. Any technique to catch the capsule may be used. In one embodiment, the capsule is captured in a sieve. For example, a witch's hat or other sieve in the pipeline filters the fluid. The capsule is large enough to be captured by this filtering. In other embodiments, the capsule is captured magnetically.

The catching of the capsule may leave the capsule in the pipeline, at least during recovery of the images. Alternatively, the capsule is removed from the pipeline for the recovery of images. The sieve may be removed, the capsule collected, and the sieve cleaned and returned to the pipeline.

In act 50, the measurements are recovered from the capsule. For example, images stored in the capsule are downloaded or dumped to another memory. A transmitter, once activated by acoustic interrogation, movement pattern, exposure to light, electronic interrogation, or other interrogation, transmits the recorded images. Any format may be used, such as Bluetooth or Wi-Fi.

The recovery is wireless. In alternative embodiments, a cord or portable memory is plugged into the capsule for recovery of the measurements.

The images are recovered once the capsule is captured. Alternatively, the capsule transmits the images while moving in the pipeline. Antennae along or within the pipeline receive the transmissions to recover the images and indicate a location along the pipeline associated with the images.

In act 52, motion compensation is applied to the images or sensed measurements. The motion compensation spatially aligns the images. Since the capsule may move and rotate in different directions, the scale, rotation and translation of the images vary. A given camera may image in different directions and/or ranges at different times. These collections of images are spatially aligned, at least longitudinally along the pipeline. Twist may remain or be removed from the images.

Any motion compensation may be used. The motion compensation may be based on image processing, such as correlating structured light patterns together to spatially align. In other embodiments, relative position measurements are used to align the images.

The images, as aligned, may be viewed in sequence. As aligned, a conceptual line along the length of the pipeline is imaged by different cameras at different times due to the rotating. By accounting for the rotating, moving along the length, and moving along the axis perpendicular to the length, the video may be stabilized.

The motion compensation occurs as part of capturing the image or is performed after recovering the images. The overlapping regions from different cameras are registered to aid in the reconstruction of the three-dimensional interior of the pipeline. Once aligned, structured light may be analyzed, taking into account the cylindrical environment. As an example, if one camera is pointed down the barrel of the pipe, the camera directly opposite may see a similar view (assuming a straight stretch of pipe). The cameras orthogonal to this point of view should view pipe walls.

The images, whether motion compensated or not, may be used to identify the location of inconsistencies in the pipeline. The identification may be manual, such as a person viewing the images. The identification may be automatic, such as a processor applying image processing.

The structured light may be analyzed, once aligned or without alignment, to find any inconsistencies in the pipeline. For example, what should be a straight or consistently curving line of light on the wall of the pipeline may have a break or unusual angle, indicating an inconsistency. A reflectivity, color, or other indicator in images may additionally or alternatively be used to identify an inconsistency.

The images or motion compensated images may be used to determine the location of any inconsistency. For example, seams or other regular structures may be viewable in the images. By counting the seams or structures, a general location along the pipeline may be determined.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A system for pipeline inspection, the system comprising:
a pipeline having an inner diameter;
a pig comprising a maximum dimension less than half of the inner diameter, the pig being free of a tether such that the pig with the maximum dimension is operable to rotate along any of three orthogonal axes within the pipeline; and
a sensor connected with the pig, the sensor operable to scan an interior of the pipeline as the pig progresses along the pipeline within the pipeline.

2. The system of claim 1 further comprising a chemical injection line having a smaller diameter than the inner diameter of the pipeline, the chemical injection line connected with the pipeline, wherein a size of the pig allows the pig to be inserted into the pipeline through the chemical injection line.

3. The system of claim 1 wherein the maximum dimension is three inches or less and wherein the pig with the three inch or less is operable for use in pipelines of various sizes, including the pipeline with the inner diameter.

4. The system of claim 1 wherein the pig comprises a plastic housing.

5. The system of claim 1 wherein the pig comprises a sapphire window, and wherein the sensor comprises a camera and an imaging lens adjacent the sapphire window

6. The system of claim 1 wherein the pig comprises a lens coated with an oleophobic topcoat, and wherein the sensor comprises a camera adjacent to the lens.

7. The system of claim 1 wherein the pig comprises a housing having recesses, wherein the sensor is one of a plurality of sensors, the sensors positioned within respective ones of the recesses such that the sensors are spaced from an outer surface of the housing.

8. The system of claim 1 wherein the pig comprises a piezoelectric transducer operable to vibrate the pig.

9. The system of claim 1 wherein the pig comprises a structured light projector adjacent to the sensor.

10. The system of claim 1 wherein the pig comprises an inertial sensor, an acoustic sensor, or both in addition to the sensor.

11. The system of claim 1 wherein the pig comprises a Dewar vessel, the sensor within the Dewar vessel.

12. A pipeline inspection pig comprising:
a housing;
a plurality of cameras connected with the housing, the plurality of cameras arranged to have a combined field of view which encompasses all directions;
a memory within the housing and connected with the cameras, the memory operable to store images from the cameras; and
a power source within the housing and connected with the cameras.

13. The pipeline inspection pig of claim 12 wherein the housing comprises a sphere with a diameter less than five inches, a plurality of lenses on a surface of the sphere, the cameras positioned adjacent to the lenses, respectively, and wherein the housing is free of a tether for operation in a pipeline.

14. The pipeline inspection pig of claim 12 wherein the housing comprises a Dewar vessel, the cameras within the Dewar vessel.

15. The pipeline inspection pig of claim 12 further comprising a plurality of structured light projectors.

16. A method for inspecting a pipeline, the method comprising:
placing a capsule into a pipeline;
recording images of the pipeline as the capsule moves along a length of the pipeline and moves along an axis perpendicular to the length of the pipeline; and
applying motion compensation to the images.

17. The method of claim 16 wherein placing the capsule into the pipeline comprises inserting the capsule into a chemical feeder line and the capsule passing from the chemical feeder line into the pipeline such that shutting down production from the pipeline for placing the capsule into the pipeline is avoided.

18. The method of claim 16 wherein a maximum length of the capsule is less than half an inner diameter of the pipeline, the capsule rotating about any of three orthogonal axes within the pipeline, wherein a conceptual line along the length of the pipeline is imaged by different cameras at different times due to the rotating, and wherein applying motion compensation comprises accounting for the rotating, moving along the length, and moving along the axis perpendicular to the length.

19. The method of claim 16 wherein recording the images comprises recording images from fields of view covering all directions from the capsule.

20. The method of claim 16 further comprising:
catching the capsule at a filter in the pipeline; and
recovering the images from the capsule after catching the capsule.

21. The method of claim 16 further comprising:
insulating cameras in the capsule.
